(19) United States
(12) Patent Application Publication
(10) Pub. No.: US 2007/0199477 A1
(43) Pub. Date: Aug. 30, 2007

(54) Paste containing nanoscale powder and dispersant and dispersion made therefrom

(75) Inventors: Sven Hill, Aschaffenburg (DE); Kathrin Lehmann, Leverkusen (DE); Pedro Cavaleiro, Viersen (DE); Stefan Heberer, Gelnhausen-Meerholz (DE); Markus Pridoehl, Grosskrotzenburg (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/509,741

(22) Filed: Aug. 25, 2006

(30) Foreign Application Priority Data
Aug. 25, 2005 (DE) 102005040157.0

(51) Int. Cl. C09D 11/00; C08K 5/00

(52) U.S. Cl. 106/287.13; 106/499; 106/287.16; 106/287.14; 106/287.23; 106/287.24; 106/287.25; 106/31.65

(57) ABSTRACT

A paste is provided having as solid phase at least one nanoscale powder and as liquid phase at least one dispersant, wherein the fraction of the nanoscale powder is 30% to 95% by weight and the fraction of the liquid phase is at least 5% by weight, based in each case on the total amount of the paste, the paste has a water content of less than 3% by weight of water and the liquid phase has a VOC content of less than 10 g/l, and the use of the paste in preparing dispersions, the dispersions prepared thereby, and use in a variety of other enduses.

### BACKGROUND OF THE INVENTION

1. Field of Invention

The present invention relates to a paste comprising one or more nanoscale powders as solid phase and a dispersant as liquid phase, and dispersions made therefrom.

2. Discussion of the Background

Pigment pastes are normally composed of water and/or an organic solvent, at least one pigment, at least one binder and, if desired, further organic solvents, wetting agents and other typical pigment-paste additives (cf. Volker Radke in “Pigmente fur Anstrichmittel”, Technische Akademie Esslingen, Chapter 7, Dispergierung von Pigmenten [Dispersing of Pigments], Export-Verlag, 1990).

In addition there are also binder-free paste systems known which are composed of water and/or an organic solvent, at least one pigment, at least one dispersant, and, if desired, further organic solvents, wetting agents and other typical pigment-paste additives.

In order for the pigment pastes to be as universally useful as possible and thus to allow the cost-effective preparation of a multiplicity of, in some cases, very different coatings, inks and/or paints, these pigment pastes ought to have very high filling levels and ought to be compatible with a very large number of coating, ink and paint systems.

These requirements commonly lead to a variety of problems, such as, for example, high pigment-paste viscosity, inadequate pigment-paste storage stability (in general, the desire is for a pigment-paste storage stability of at least 6 months in storage at room temperature or of 1 month in storage at 40° C.) or poor dispersibility (i.e. a high specific energy input is required for dispersion or the pigment paste thickens during the dispersing operation, or there is a tendency for sedimentation).

As observed above, pigment pastes conforming to the prior art contain either water or organic solvents in order to minimize the viscosity of the pigment pastes, while still being able to realize high filling levels. However, in particular, water and/or organic solvents significantly restrict the universal usefulness of pigment pastes. Water can lead to turbidity and disruptions in organic, non-polar paint systems. In reactive, two-component isocyanate crosslinking paint systems, water often leads to unwanted side reactions, such as bubbling or foaming.

Conversely, organic solvents can lead to incompatibility in aqueous ink and paint systems. Low molecular mass volatile compounds in particular are of only limited suitability as solvents for paste systems, since they burden the environment as a result of odors and/or volatile solvent constituents (VOCs, volatile organic compounds) and harbour the risk of the formation of explosive gas mixtures.

An objective pursued is that of further reducing the VOC content in all coating, ink and paint systems (cf. “German Chemicals law ordinance on the limiting of emissions of volatile organic compounds (VOCs) by restricting the marketing of solvent-containing paints and varnishes (Solvent-containing paint and varnish ordinance—ChemVOCFarbV)” and “31st BImSchV—Ordinance on the limiting of emissions of volatile organic compounds in connection with the use of organic solvents in certain installations”).

There is therefore a growing demand for paste systems which exhibit properties further improved over those of the prior art. In particular there is great interest in paste systems which can be employed across a broad spectrum of applications, such as coatings, inks, including printing inks, and adhesives, for example. In all of these applications the properties of the paste ought to be retained when it is incorporated into, say, a paint system. Thus, for instance, reagglomeration of the particles present in the paste ought to be avoided. The paste should also be such that the burdening of the environment with volatile organic compounds (VOCs) is reduced or avoided entirely, and such that the paste exhibits high filling levels and a sufficient storage stability.

### SUMMARY OF THE INVENTION

Accordingly, one object of the present invention is to provide a paste containing a nanoscale powder that can be used in a wide variety of end use applications.

A further object of the present invention is to provide a paste having low VOCs while maintaining high filling levels and sufficient storage stability.

A further object of the present invention is to provide methods for production of such a paste.

Another object of the present invention is to provide a dispersion prepared from the paste.

Another object of the present invention is to provide a variety of end use applications, such as paints, inks, coatings, adhesives and moldings, which incorporate the paste.

These and other objects of the invention, either singly or in combinations, have been satisfied by the discovery of a paste, comprising as solid phase at least one nanoscale powder and as liquid phase at least one dispersant, wherein
the nanoscale powder is present in an amount of from 30% to 95% by weight and the liquid phase is at least 5% by weight, based in each case on total amount of the paste,
the paste has a water content of less than 3% by weight and
the liquid phase has a VOC content of less than 10 g/l;
methods for its production, a dispersion prepared from the paste and use of the paste in a variety of end use applications.

### DETAILED DESCRIPTION OF THE INVENTION

The present invention relates to a paste comprising as a solid phase at least one nanoscale powder and as a liquid phase at least one dispersant, wherein
the fraction of the nanoscale powder is 30% to 95% by weight and the fraction of the liquid phase is at least 5% by weight, based in each case on the total amount of the paste,
the paste has a water content of less than 3% by weight of water and
the liquid phase has a VOC content of less than 10 g/l.

A paste for the purposes of the present invention is a solid/liquid system which comprises at least one nanoscale powder and at least one dispersant, but no solvent or only in amounts such that the VOC content of the paste is less than 1% by weight.

By dispersants are meant agents which facilitate the dispersing of particles in a dispersion medium, the liquid phase of a dispersion, by reducing the surface tension. The property of the dispersant in reducing the surface tension between the solid and the liquid phase and thereby facilitating the dispersing of the particles is manifested when the paste of the invention is converted in a subsequent step into a dispersion with an aqueous or organic liquid. The dispersants assist the disruption of agglomerates, as surface-active materials wet or coat the surface of the particles to be dispersed, and stabilize them with respect to unwanted reagglomeration.

By dispersion for the purposes of the invention is meant a solid/liquid system in which the solid phase comprises a nanoscale powder and the liquid phase comprises at least one dispersant and at least one solvent. Depending on the choice of solvent the VOC content of the dispersion may be greater or less than 1% by weight. The solvent may be water or a polar and/or a non-polar organic solvent.

By volatile organic compound (VOC) is meant any organic compound which at 293.15 K has a vapour pressure of 0.01 kPa or more.

By organic compound is meant any compound which contains at least the element carbon and, in addition, one or more of hydrogen, halogens, oxygen, sulphur, phosphorus, silicon or nitrogen, with the exception of carbon dioxide and inorganic carbonates and bicarbonates.

Nanoscale powders for the purposes of the invention are powders having an average aggregate or agglomerate size ≦1000 nm and/or a primary particle size ≦100 nm.

By particle-bound water is meant water which is bound adsorptively to the particle surface. The amount may be reduced by means of appropriate methods.

By establishment of equilibrium is meant the distribution of the particle-bound water between solid and liquid phase in the paste of the invention.

The VOC content of the liquid phase may preferably be less than 1 g/l.

In addition it may be advantageous if the liquid phase of the paste of the invention has a water content of less than 0.1% by weight.

In addition it may be advantageous if the nanoscale powder of the paste of the invention contains not more than up to 3% by weight of water which is particle-bound in accordance with the establishment of equilibrium.

The fraction of the nanoscale powder, based on the total amount of the paste, is preferably 60% to 90% by weight and with particular preference 75% to 85% by weight.

In addition the nanoscale powder is substantially evenly distributed in the paste. If the amounts of nanoscale powder are measured at different points in a paste, the values found differ generally by not more than ±5% from the average. Advantageously the values differ by not more than ±1%, a range of ±0.1% being particularly preferred.

The average diameter of the nanoscale particles in the paste of the invention are preferably less than 300 nm and more preferably less than 200 nm.

The nature and the origin of the nanoscale powders present in the paste of the invention is not limited. Preferably, however, the nanoscale powders are present in the form of at least one member selected from a metal, a metal oxide, a metal boride, a metal carbide, a metal carbonate, a metal nitride, a metal phosphate, a metal chalcogenide, a metal sulphate, a metal halide and mixtures thereof. The metal can be any metal, and is preferably at least one member selected from Li, Na, K, Rb, Cs, Be, Mg, Ca, Sr, Ba, Sc, Y, La, Ce, Pr, Nd, Sm, Eu, Gd, Tb, Ti, Zr, Hf, V, Nb, Ta, Cr, Mo, W, Mn, Fe, Co, Ni, Cu, Ag, Zn, Cd, Hg, B, Al, Ga, In, Te, Se, Tl, Si, Ge, Sn, Pb, P, As, Sb, Bi, and mixtures thereof. For the purposes of the invention the nonmetals B, Si, and P are also to be included as well.

In particular a metal oxide which contains one or more of the elements Si, Al, Ti, Fe, Ce, In, Sb, Sn, Zn, Y and/or Zr is preferable. It is particularly advantageous if the paste of the invention comprises mixed metal oxides such as indium tin oxide, antimony tin oxide, mixed oxides with a matrix domain structure such as, for example, those described in EP-A-1284485 or in EP-A-1468962.

In particular the paste of the invention may also comprise a metal oxide prepared by precipitation, as described for example in WO 00/14017.

The paste of the invention may further comprise surface-modified nanoscale powders, especially metal oxides. The surface modification comprises adsorption, surface reactions or complexing of the surface with organic and/or inorganic reagents. The paste of the invention may, for example, comprise a nanoscale cerium oxide powder whose surface carries carbonate groups. A powder of this kind is disclosed in the German patent application with the application number 10 2005 038 136.7 and the 12.08.2005 as filing date, the contents of which are hereby incorporated by reference.

The surface modification also comprises the adsorption of bioorganic materials, such as nucleic acids or polysaccharides.

The paste of the invention comprises in addition to the nanoscale powder at least one dispersant. Preferably the paste of the invention may comprise a dispersant which is a styrene oxide-based polyalkylene oxide with random distribution or is a block copolymer of the general formula 1,
R¹O(SO)ₐ(EO)_{b}(PO)_{c}(BO)_{d}R² (1),
in which
R¹=a linear, branched or cycloaliphatic radical having 8 to 13 carbon atoms
R²=hydrogen, an acyl radical, alkyl radical or carboxylic acid radical having in each case 1 to 8 carbon atoms,
SO=styrene oxide, EO=ethylene oxide, PO=propylene oxide, BO=butylene oxide and
a=1 to 5, b=3 to 50, c=0 to 3, d=0 to 3, and b≧a+c+d.

Dispersants with a =1 to 1.9 are described for example in EP-A-1078946.

The paste of the invention may further comprise a dispersant which is a phosphoric ester of the general formula 2, 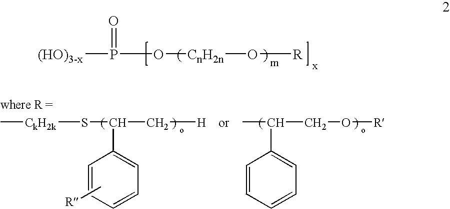
in which
x is 1 or 2,
n is a number from 2 to 18
m and o are each, independently, a number from 2 to 100,
k is a number from 2 to 4,
R″ is H or a linear or branched alkyl radical, which optionally may be substituted by additional functional groups, and
R′ is an alkyl, alkaryl, alkenyl or sulphopropyl radical.

Preferably R″=H. R′ is commonly derived from an alcohol R′OH which functions as a starter alcohol for the polymerization of the styrene oxide and alkylene oxide. Examples of the radicals R′ are the methyl, butyl, stearyl, allyl, hexenyl, nonylphenyl or oleyl radical. Preferred for R′ are methyl and butyl radicals.

Dispersants of this kind are described for example in EP-A-940406.

The terminal OH groups may also be in anionically modified form, such as sulphated, sulphonated, phosphorylated (see general formula 2) or else carboxy-modified.

The paste of the invention may further comprise a dispersant which comprises block copolymers and their salts of the general formula 2a,
[R¹O(SO)ₐ(EO)_{b}(CH₂CHCH₃O)_{c}(BO)_{d}]ₓP(═O)(OH)₃₋ₓ 2a

in which R′=a linear, branched or cycloaliphatic radical having 1 to 22 carbon atoms, SO=styrene oxide, EO=ethylene oxide, BO=butylene oxide and a=1 to <2, b=0 to 100, c=0 to 10, d=0 to 3, and b is >a+c+d.

The paste of the invention may further comprise a dispersant which is obtainable by the partial or complete reaction of
A) one or more amino-functional polymers with
B) one or more polyesters of the general formulae (3)/(3a) T-C(O)-[O-A-C(O)]ₓ—OH (3), T-O-[C(O)-A-O-]_{y}-Z ((3a) and
C) one or more polyethers of the general formula (4)/(4a) T-C(O)—B-Z (4), T-O—B-Z (4a), wherein
T is a hydrogen radical and/or an optionally substituted, linear or branched aryl, arylalkyl, alkyl or alkenyl radical having 1 to 24 carbon atoms,
A is at least one divalent radical selected from the group of linear, branched, cyclic and aromatic hydrocarbon radicals,
Z is at least one radical selected from the group of sulphonic acids, sulphuric acids, phosphonic acids, phosphoric acids, carboxylic acids, isocyanates, and epoxides, in particular of phosphoric acid and (meth)acrylic acid,
B is a radical of the general formula (5)
   —(CₗH₂ₗO)ₐ—(CₘH₂ₘO)_{b}—(CₙH₂ₙO)_{c}—(SO)_{d}— (5)
a,b,c are each, independently, values from 0 to 100, with the proviso that the sum of a+b+c≧0, preferably 5 to 35, in particular 10 to 20, with the proviso that the sum of a+b+c+d>0,
d is ≧0, preferably 1 to 5,
l, m, and n are each, independently, ≧2, preferably 2 to 4, and
x and y are each, independently, ≧2.

The reaction products may be in the form of the amides and/or of the corresponding salts. Where the moiety “Z” contains a multiple bond, as may be the case, for example, for the polyethers and for the polyesters prepared starting from alcohol, and in which the terminal OH group has been esterified with an unsaturated acid such as (meth)acrylic acid, bonding is via a Michael addition of the NH function onto the double bond.

Examples of amino-functional polymers include, but are not limited to, amino-functional polyamino acids such as polylysine from Aldrich Chemical Co.; amino-functional silicones obtainable under the trade name Tegomer® ASi 2122 from Degussa AG; polyamidoamines obtainable under the trade name Polypox®, Aradur® or “Starburst®” dendrimers from Aldrich Chemical Co.; polyallylamines and Poly(N-alkyl)allylamines obtainable under the trade name PAA from Nitto Boseki; polyvinylamines obtainable under the trade name Lupamin® from BASF AG; polyalkyleneimines, such as polyethyleneimines for example, which are obtainable under the trade name Epomin(® (Nippon Shokubai Co., Ltd.), Lupasol® (BASF AG); polypropyleneimines which are obtainable under the trade name Astramol® from DSM AG. Further examples of amino-functional polymers are represented by the abovementioned systems through crosslinking with amino-reactive groups. This crosslinking reaction takes place, for example, by way of polyfunctional isocyanates, carboxylic acids, (meth)acrylates and epoxides. Further examples are poly(meth)acrylate polymers, which include dimethylaminopropyl(meth)acrylamide (Degussa AG) or dimethylaminoethyl (meth)acrylate (Degussa AG) as monomers.

Typically, amino-functional polymers having a molecular weight of 400 g/mol to 600 000 g/mol are used.

Examples of the radical T include, but are not limited to, alkyl radicals having 1 to 24 carbon atoms, such as the methyl, ethyl, propyl, isopropyl, butyl, isobutyl, tert-butyl, hexyl, isohexyl, octyl, nonyl, isononyl, decyl, dodecyl, hexadecyl and octadecyl radical. Examples of optionally substituted aryl or arylalkyl radicals having up to 24 carbon atoms include, but are not limited to, the phenyl, benzyl, tolyl or phenethyl radical.

The polyester groups -[O-A-C(O)]ₓ- and —[C(O)-A-O-]_{y}- contain on average more than two ester groups and have an average molecular weight Mₙ of 100 to 5000 g/mol. Particular preference is given to a value of Mₙ=200 to 2000 g/mol.

One particularly preferred embodiment of the present invention is characterized in that the polyester group is obtained by conventional methods, by ring-opening polymerization with a starter molecule such as T-CH₂—OH or T-COOH and one or more lactones, such as, for example β-propiolactone, β-butyrolactone, γ-butyrolactone, 3,6-dimethyl-1,4-dioxane-2,5-dione, δ-valerolactone, γ-valerolactone, ε-caprolactone, γ-caprolactone, 4-methylcaprolactone, 2-methylcaprolactone, 5-hydroxy-dodecanolactone, 12-hydroxydodecanolactone, 12-hydroxy-9-octadecenoic acid, 12-hydroxyoctadecanoic acid.

Starter molecules such as T-COOH— and also the fatty alcohols T-CH₂—OH preparable from them—are preferably the monobasic fatty acids that are known and typical in this field and are based on natural vegetable or animal fats and oils having 6 to 24 carbon atoms, in particular having 12 to 18 carbon atoms, such as caproic acid, caprylic acid, capric acid, lauric acid, myristic acid, palmitic acid, palmitoleic acid, isostearic acid, stearic acid, oleic acid, linolic acid, petroselinic acid, elaidic acid, arachidic acid, behenic acid, erucic acid, gadoleic acid, rapeseed oil fatty acid, soya oil fatty acid, sunflower oil fatty acid, tall oil fatty acid, which can be used alone or in a mixture in the form of their glycerides, methyl esters or ethyl esters, or in the form of free acids, and also the technical mixtures which are obtained in the course of pressure cleavage. In principle all fatty acids with a similar chain distribution are suitable.

The amount of unsaturated fractions in these fatty acids and/or fatty acid esters is adjusted—where necessary—to a desired iodine number by means of known catalytic hydrogenation methods or by blending fully hydrogenated with non-hydrogenated fatty components. The iodine number, as a measure of the average degree of saturation of a fatty acid, is the amount of iodine absorbed by 100 g of the compound in order to saturate the double bonds.

Not only the fatty acids but also the resultant alcohols can be modified by addition reaction with alkylene oxides, especially ethylene oxide and/or styrene oxide.

Examples of the polyether building blocks of B include, but are not limited to, alkylene oxides such as the following: ethylene oxide, propylene oxide, butylene oxide, styrene oxide, dodecene oxide, tetradecene oxide, 2,3-dimethyloxirane, cyclopentene oxide, 1,2-epoxypentane, 2-isopropyloxirane, glycidyl methyl ester, glycidyl isopropyl-ester, epichlorohydrin, 3-methoxy-2,2-dimethyloxirane, 8-oxabicyclo[5.1.0]octane, 2-pentyloxirane, 2-methyl-3-phenyloxirane, 2,3-epoxypropylbenzene, 2-(4-fluorophenyl)oxirane, tetrahydrofuran, and also their pure enantiomer pairs or enantiomer mixtures.

The group Z may be constructed from addition products of the carboxylic anhydrides such as, for example, succinic anhydride, maleic anhydride or phthalic anhydride.

The proportion by weight of polyester to polyether in the dispersing resin of the invention is between 50:1 and 1:9, preferably between 40:1 and 1:5 and more preferably between 30:1 and 1:1.

The paste of the invention may further comprise a dispersant which is an organopolysiloxane of the general formula 6 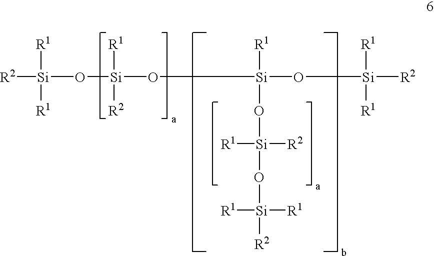
in which the radicals
R¹ are alkyl radicals having 1 to 4 carbon atoms or aryl radicals, but at least 80% of the radicals R¹ are methyl radicals,
R² are identical or different in the molecule and can have the following definitions a)-d):
a) 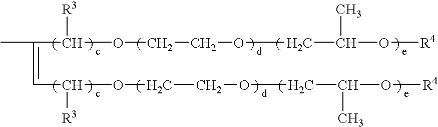
wherein
R³ is a hydrogen or alkyl radical,
R⁴ is a hydrogen, alkyl or carboxyl radical,
c is a number from 1 to 20,
d is a number from 0 to 50, e is a number from 0 to 50,
or
b) —(CH₂—)_{f}OR⁵,
wherein
R⁵ is a hydrogen, alkyl, carboxyl radical or a dimethylolpropane radical optionally containing ether groups,
f is a number from 2 to 20,
or
c) —(CH₂—)_{g}(OC₂H₄—)ₕ(OC₃H₆—)ᵢ(OC₄H₈)ⱼ(OCH₂CH(C₆H₅))ₖOR⁶
wherein
R⁶ is a hydrogen, alkyl or carboxyl radical,
g is a number from 2 to 6,
h is a number from 0 to 20,
i is a number from 1 to 50,
j is a number from 0 to 10,
k is a number from 0 to 10
or
d) correspond to the radical R¹, with the proviso that in the average molecule at least one radical R² has the definition (a), a being a number from 1 to 500, preferably from 1 to 200 and more preferably 1 to 50 and b being a number from 0 to 10, preferably <5 and more preferably 0.
Preferably it is possible for R¹ to be methyl radicals, a=1-50 and b=0. Preferably it is possible for R³ to be hydrogen. Preferably it is possible for R⁴ to be hydrogen or an acrylic radical. Preferably it is possible for index c=1 or 2 and d and e independently of one another to be 0 to 10.

Dispersants of this kind are described for example in EP-A-1382632.

The paste of the invention may further comprises as dispersant a copolymer based on styrene oxide-based oxyalkylene glycol alkenyl ethers or polyalkylene oxide alkenyl ethers and unsaturated carboxylic acid, preferably dicarboxylic acid derivatives, with
a) 1 to 80 mol % of at least one of the constituent groups of the formula 7a, 7b, 7c and/or 7d 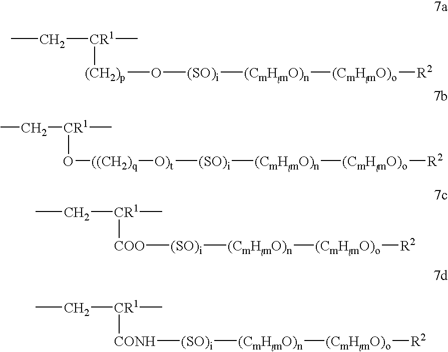
wherein
   R¹═H, or an aliphatic hydrocarbon radical having 1 to 5 carbon atoms,
   p=1-4, q=0-6, t=0-4, i=1-6, l=1-2, m=2-18,
   the index on the H atom being formed by the product of l and m,
   n=0-100, o=0-100, SO=styrene oxide, it being possible for (SO)ᵢ and the alkylene oxide derivatives to be distributed randomly or blockwise in the polyether, but preferably the groups are in blockwise construction and follow the sequence
      —(SO)ᵢ—[(CₘHₗₘO)ₙ—(CₘHₗₘO)ₒ]—R²;
   R²═H, an aliphatic, optionally branched hydrocarbon radical having 1 to 20 carbon atoms, a cycloaliphatic hydrocarbon having 5 to 8 carbon atoms, an aryl radical having 6 to 14 carbon atoms, which is optionally substituted or may be a phosphoric ester (preferably monoester) derivative, sulphate derivative or sulphonate derivative;
b) 1 to 90 mol % of constituent groups of the formula 8 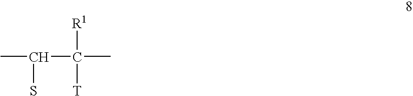
   in which
   S═—H, —COOMₐ, —COOR³,
   M=hydrogen, monovalent or divalent metal cation, ammonium ion, organic amine radical,
   a=1 or if M is a divalent metal cation, is ½,
   R³=an aliphatic, optionally branched hydrocarbon radical having 1 to 20 carbon atoms, a cycloaliphatic hydrocarbon having 5 to 8 carbon atoms, an aryl radical having 6 to 14 carbon atoms,
   T═—U¹—R⁴ or —U¹—(CₘHₗₘO)ₙ—(CₘHₗₘO)ₒ—R²,
   U¹═—COO—, —CONH—, —CONR³—, —O—, —CH₂O—,
   R⁴═H, Mₐ, R³ or -Q¹-NQ²Q³,
   in which
   Q¹ is a divalent alkylene radical having 2 to 24 carbon atoms,
   Q² and Q³ are aliphatic and/or alicyclic alkyl radicals having 1 to 12 carbon atoms, optionally oxidized to
      -Q¹-N(+)O(−)Q²Q³
   and
   m, n, l, o, R¹ and R² are as defined above,
c) 0 to 10 mol % of constituent groups of the formula 9 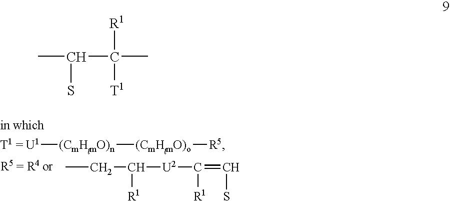
   in which U²═—OOC—, —NHOC—, —O—, —O—CH₂—,
   and m, n, l, o, S, R¹, R² and U¹ are as defined above.

Dispersants of this kind are described for example in DE-A-10348825.

Preferably the paste of the invention comprises a solid phase of at least one nanoscale powder and a liquid phase of at least one dispersant.

The invention further provides a process for preparing the paste of the invention, in which the nanoscale powder is incorporated all at once, continuously or in portions under dispersing conditions into the liquid phase. The dispersing can take place for example with a mortar, roll mill, ball mill, rotor-stator, planetary kneader or with other dispersing assemblies known to the skilled person.

The invention additionally provides a dispersion obtained from the paste of the invention and a solvent. The solvent may be water, one or more polar organic solvents and/or one or more non-polar organic solvents. Preferably, the nanoscale powder content is 0.5% to 50% by weight, based on the dispersion.

The invention additionally provides a process for preparing the dispersion of the invention, in which the paste is combined by stirring or by shaking with a solvent or solvent mixture.

The invention additionally provides for the use of the paste of the invention for preparing paints, (printing) inks, coatings, adhesives and mouldings, using conventional methods for preparation of such paints, inks, coatings, adhesives and mouldings.

### EXAMPLES

Analysis

The VOC content is determined in accordance with DIN EN ISO 11890-1. The VOC content is calculated with water deducted in accordance with method 8.4. The water content is determined titrimetrically by the Karl Fischer method (ISO 760).

Particle Size Determination by Means of PCS:

The particle size is determined by means of dynamic light scattering in a 1 per cent dispersion. Dispersing takes place by stirring, shaking or ultrasound. The particle size analyser used is the HORIBA LB-500 instrument. For precise determination of the particle size distribution, the temperature, viscosity and refractive index of particles and dispersion medium must be known.

Solids Content Determination of the Paste:

Approximately 0.2-0.3 g of the paste is weighed out into a tared glass. The precise weight of the initial sample together with glass is recorded and the glass containing the paste is calcined in a Carbolite oven at 400° C. for an hour. After the glass with the paste residue has cooled, it is weighed again. The final sample mass is divided by the initial sample mass and multiplied by 100, to give the solids content of the paste in per cent. The content is determined at different locations in a paste.

Powders

Zinc Oxide (according to WO 2005/028565):

Zinc powder (510 g/h) is transferred by means of a stream of nitrogen (4.2 m³/h (stp)) to a reductive evaporation zone in which there is a hydrogen/air flame (hydrogen: 4.0 m³/h (stp); air: 8.0 m³/h (stp)) burning. In this zone the zinc powder is evaporated. The reaction mixture of zinc vapour, hydrogen, nitrogen and water flows into the oxidation zone, where 20 m³/h (stp) air is added. The temperature prior to addition of the oxidizing air is 956° C. Subsequently 10 m³/h (stp) quenching air are added. The temperature prior to addition of the quenching air is 648° C. The zinc oxide powder obtained is separated from the gas stream by filtration.

The BET surface area of zinc oxide powder is 27 m²/g.

Indium Tin Oxide According to WO 00/14017:

140 g of indium(+III)chloride (0.63 mol anhydrous), 18 g of tin(+IV) chloride×5 H₂O and 5.6 g of caprolactam are introduced into 1400 ml of water and stirred. When a clear solution has formed it is heated to 50° C. and then 105 ml of 25 per cent strength ammonium hydroxide solution are added dropwise. The dispersion is stirred at a temperature of 50° C. for 24 hours. Subsequently a further 280 ml of ammonium hydroxide solution are added. The white precipitate is removed by centrifugation and dried in a vacuum drying oven at 190° C. until slight yellowing of the powder is observed. The dried precipitate is finely mortared and placed in a forming-gas oven. The oven is evacuated and then flooded with nitrogen. The oven is heated to 250° C. at a rate of 250° C./hour, with a nitrogen flow rate of 200 litres/hour. This temperature is held for 60 minutes under forming-gas atmosphere with a gas flow rate of 300 litres/hour. Thereafter the oven cools down under nitrogen atmosphere until it reaches room temperature (duration: approximately 5 hours). This results in a dark blue powder.

The indium tin oxide powder prepared in this way is used in Examples ITO-1 to ITO-12.

Indium Tin Oxide According to DE-A-10311645:

An aqueous solution containing 88.9 g/l indium(III) chloride and 8.4 g/l tin(IV) chloride are atomized by means of compressed air and a nozzle (diameter 0.8 mm), with a conveying rate of 1500 ml/h into the reaction tube. Here there is a hydrogen/oxygen flame burning, composed of 5 m³/h hydrogen and 15 m³/h air. The temperature 0.5 m below the flame is 750° C. 2.5 m below the flame 10 m³/h forming gas are supplied, the temperature above the site of addition being approximately 450° C. The reaction mixture passes through a 2 m residence time section in 14 seconds. Thereafter the solid is separated from the gaseous substances by means of a filter and is treated over a period of 15 minutes at a temperature of 250° C. with continuing supply of forming gas.

The In₂O₃/SnO₂ ratio is 94/6, the BET surface area 53 m²/g.

The indium tin oxide powder prepared in this way is used in Examples ITO-13 and ITO-14.

Dispersants

The dispersants used are as follows: LA-D 1045, Dispers 650, Twin 4000, Dispers 650-carboxy, Dispers 655, LA-D 868, LA-D 869. All these are from TEGO, all with a VOC<10 g/l.

Preparation of the Pastes

1. Using a mortar: The prepared zinc oxide and indium tin oxide powders and dispersants are placed in a mortar and mixed using the pestle for about 10-15 minutes.
2. Using a triple roll mill from Exakt, model Exakt 80 E: the roll mill is composed of 3 rolls which rotate in opposite directions. The middle and back roll rotate towards one another, while the front roll rotates oppositely to the middle roll. Introduced onto the rear roll are 92.82 g of zinc oxide and 7.18 g of Twin 4000 (Example ZnO-6). To set the roll zone, limiting elements are inserted into the mounting rods provided, at the rear nip. Optimum adjustment of the limiting elements is when they have been inserted into the mount up to the mark. If more material is processed, they can also be pushed further into the mount. With the aid of the front roll, the material is taken off from the middle roll, subjected to repeat shearing and transferred onto the take-off blade.
   Preparation of Dispersions

The paste of the invention is mixed with a solvent by stirring with a magnetic stirrer (10 min at highest setting), by shaking or by ultrasound.

With the pastes of the invention from Examples ZnO-1, ZnO-7, ZnO-8, ITO-1, ITO-5, ITO-7 and ITO-9 it is possible to prepare dispersions with non-polar and polar organic solvents.

With the pastes of the invention from Examples ZnO-2, ZnO-4, ZnO-6 and ITO-3 it is possible to prepare dispersions with water and polar organic solvents.

With the paste of the invention from Example ITO-2 it is possible to prepare a dispersion with water, polar and non-polar organic solvents.

The paste of the present invention has the following advantages:
It has a very low VOC content.
The addition of a solvent results in a stable dispersion (no reagglomeration).
Starting from a paste it is possible to obtain not only polar but also non-polar, aqueous or organic dispersions.
Starting from a paste it is possible to obtain the dispersions by single stirring, shaking or by means of ultrasound.

The present application is based on German Patent application DE 102005040157.0, filed Aug. 25, 2005, the entire contents of which are hereby incorporated by reference.

TABLE 1
Zinc oxide pastes of the invention

| | | | Dispersant | Paste water |
|---|---|---|---|---|
| | Powder content | | content | content |
| ZnO- | % by weight | Dispersant | % by weight | % by weight |
| 1 | 62.81 | LA-D 1045 | 35.90 | 1.25 |
| 2 | 92.4 | LA-D 1045 | 6.11 | 1.41 |
| 3 | 61.07 | Dispers 650 | 37.72 | 1.13 |
| 4 | 91.28 | Dispers 650 | 7.09 | 1.51 |
| 5 | 71.98 | Twin 4000 | 26.68 | 1.22 |
| 6 | 92.82 | Twin 4000 | 5.66 | 1.44 |
| 7 | 64.59 | Dispers 650- | 34.01 | 1.3 |
| | | carboxy | | |
| 8 | 92.56 | Dispers 650- | 6.01 | 1.38 |
| | | carboxy | | |
| 9 | 69.5 | Dispers 655 | 29.05 | 1.35 |
| 10 | 91.21 | Dispers 655 | 7.28 | 1.45 |
| 11 | 70.73 | LA-D 869 | 27.93 | 1.25 |
| 12 | 89.52 | LA-D 869 | 9.01 | 1.35 |

TABLE 2
D₅₀ values [nm] of dispersions¹⁾ starting from the zinc oxide pastes of the invention

| | ZnO— | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Ethylene | | | | | | 109 | | | 240 | 145 | | |
| glycol²⁾ | | | | | | | | | | | | |
| Phenoxy- | 122 | | | | | | 136 | | 180 | 140 | 176 | 155 |
| propanol²⁾ | | | | | | | | | | | | |
| Isopropoxy- | | | | | | | 332 | 164 | | | | |
| ethanol²⁾ | | | | | | | | | | | | |
| n-Butyl | 181 | 261 | | | 212 | 331 | 168 | 188 | | | | |
| acetate²⁾ | | | | | | | | | | | | |
| Water²⁾ | | 244 | | 280 | | | | 348 | | | | |
| Phenoxy- | | | <200 | | | | | | 160 | 130 | 153 | 146 |
| propanol³⁾ | | | | | | | | | | | | |
| Water³⁾ | | | <200 | | 248 | 204 | | | | | | |

¹⁾Solids content of dispersion: 1% by weight;
²⁾prepared using mortar;
³⁾prepared using roll

TABLE 3
Indium tin zinc oxide pastes of the invention

| | | | Dispersant | Paste water |
|---|---|---|---|---|
| | Powder content | | content | content |
| ITO- | % by weight | Dispersant | % by weight | % by weight |
| 1 | 61.93 | LA-D 1045 | 36.99 | 1.04 |
| 2 | 90.37 | LA-D 1045 | 8.39 | 1.21 |
| 3 | 65.42 | Dispers 650 | 33.42 | 1.09 |
| 4 | 89.68 | Dispers 650 | 9.15 | 1.14 |
| 5 | 70.31 | LA-D 868 | 28.50 | 1.14 |
| 6 | 64.12 | LA-D 868 | 34.72 | 1.12 |
| 7 | 62.83 | Dispers 650- | 36.10 | 1.04 |
| | | carboxy | | |
| 8 | 89.10 | Dispers 650- | 9.69 | 1.18 |
| | | carboxy | | |
| 9 | 89.81 | LA-D 869 | 8.92 | 1.22 |
| 10 | 84.12 | LA-D 869 | 14.60 | 1.18 |
| 11 | 74.56 | Twin 4000 | 24.39 | 1.01 |
| 12 | 84.12 | Twin 4000 | 14.72 | 1.12 |
| 13 | 60.80 | LA-D 1045 | 38.12 | 1.07 |
| 14 | 86.30 | LA-D 1045 | 12.51 | 1.13 |

TABLE 4
D₅₀ values [nm] of dispersions¹⁾ starting from the indium tin zinc oxide
pastes of the invention

| | ITO— | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| Ethylene | | | | | | | | | 351 | | | | | |
| glycol | | | | | | | | | | | | | | |
| Methoxy- | | | 281 | | 257 | | 814 | | | | | | | |
| propanol | | | | | | | | | | | | | | |
| Phenoxy- | 82 | 61 | 80 | 120 | 84 | 110 | 79 | 122 | 87 | 98 | 266 | 295 | 120 | 115 |
| propanol | | | | | | | | | | | | | | |
| n-Butyl | 127 | 106 | | 168 | 126 | 150 | 118 | 181 | 162 | 190 | 173 | 210 | 160 | |
| acetate | | | | | | | | | | | | | | |
| Water | | 91 | 109 | 201 | 257 | 293 | | | | | | | | |

¹⁾Solid content of the dispersion: 1% by weight; prepared using mortar

1. A paste, comprising as solid phase at least one nanoscale powder and as liquid phase at least one dispersant, wherein
the nanoscale powder is present in an amount of from 30% to 95% by weight and the liquid phase is at least 5% by weight, based in each case on total amount of the paste,
the paste has a water content of less than 3% by weight and
the liquid phase has a VOC content of less than 10 g/l.

2. The paste according to claim 1, wherein the liquid phase has a VOC content of less than 1 g/l.

3. The paste according to claim 1, wherein the liquid phase has a water content of less than 0.1% by weight.

4. The paste according to claim 1, wherein the nanoscale powder contains up to 3% by weight, based on the paste, of water which is particle-bound in accordance with establishment of equilibrium.

5. The paste according to claim 1, wherein the nanoscale powder is present in an amount of from 60% to 90% by weight, based on the total amount of the paste.

6. The paste according to claim 1, wherein the nanoscale powder is evenly distributed in the paste.

7. The paste according to claim 1, wherein the nanoscale particles have an average diameter of less than 300 nm.

8. The paste according to claim 1, wherein the nanoscale powder is at least one member selected from the group consisting of a metal, a metal oxide, a metal boride, a metal carbide, a metal carbonate, a metal nitride, a metal phosphate, a metal chalcogenide, a metal sulphate, a metal halide and mixtures thereof.

9. The paste according to claim 8, wherein the nanoscale powder is a metal oxide.

10. The paste according to claim 9, wherein the metal oxide comprises at least one member selected from the elements Si, Al, Ti, Fe, Ce, In, Sb, Sn, Zn, Y, Zr and mixtures thereof.

11. The paste according to claim 1, wherein the paste has been modified by adsorption, surface reaction or complexing of the paste with organic reagents, inorganic reagents or both.

12. The paste according to claim 1, wherein the dispersant is a styrene oxide-based polyalkylene oxide with random distribution or is a block copolymer of the general formula 1,
R¹O(SO)ₐ(EO)_{b}(PO)_{c}(BO)_{d}R² (1)
wherein
R¹=a linear, branched, or cycloaliphatic radical having 8 to 13 carbon atoms
R²=hydrogen, an acyl radical, alkyl radical or carboxylic acid radical having in each case 1 to 8 carbon atoms,
SO=styrene oxide, EO=ethylene oxide, PO=propylene oxide, BO=butylene oxide and
a=1 to 5, b=3 to 50, c=0 to 3, d=0 to 3, and b>a+c+d.

13. The paste according to claim 1, wherein the dispersant is a phosphoric ester of the general formula 2, 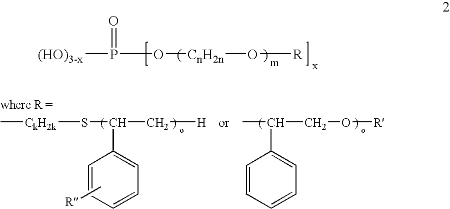
wherein
x is 1 or 2,
n is a number from 2 to 18
m and o are each a number from 2 to 100,
k is a number from 2 to 4,
R″ is H or a linear or branched alkyl radical, which optionally may be substituted by additional functional groups, and
R′ is an alkyl, alkaryl, alkenyl or sulphopropyl radical.

14. The paste according to claim 1, wherein the dispersant is obtained by partial or complete reaction of
A) one or more amino-functional polymers with
B) one or more polyesters of the general formulae (3)(3a) T-C(O)-[O-A-C(O)]ₓ-OH (3), T-O-[C(O)-A-O-]_{y}-Z((3a) and
C) one or more polyethers of the general formula (4)/(4a) T-C(O)—B-Z (4), T-O—B-Z (4a), wherein
T is in each case, independently, a hydrogen radical, an optionally substituted, linear or branched aryl, arylalkyl, alkyl or alkenyl radical having 1 to 24 carbon atoms,
A is at least one divalent radical selected from the group of linear, branched, cyclic and aromatic hydrocarbon radicals,
Z is at least one radical selected from the group of sulphonic acids, sulphuric acids, phosphonic acids, phosphoric acids, carboxylic acids, isocyanates, epoxides, in particular of phosphoric acid and (meth)acrylic acid,
B is a radical of the general formula (5)
—(C₁H₂₁O)ₐ—(CₘH₂ₘO)_{b}—(CₙH₂ₙO)_{c}—(SO)_{d}— (5)
a,b,c each, independently, are values from 0 to 100, with the proviso that the sum of
a+b+c≧0, with the proviso that the sum of a+b+c+d>0,
d is ≧0,
l, m, and n each, independently, are ≧2, and
x and y each, independently, are ≧2.

15. The paste according to claim 14, wherein the sum of a+b+c is from 5 to 35.

16. The paste according to claim 15, wherein the sum of a+b+c is from 10 to 20.

17. The paste according to claim 14, wherein d is from 1 to 5.

18. The paste according to claim 14, wherein 1, m, and n independently of one another are each from 2 to 4.

19. The paste according to claim 1, wherein the dispersant is an organopolysiloxane of the general formula 6 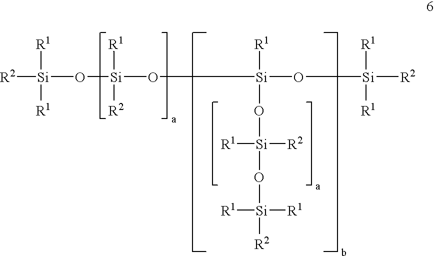
wherein the radicals
R¹ are alkyl radicals having 1 to 4 carbon atoms or aryl radicals, but at least 80% of the radicals R¹ are methyl radicals,
R² are identical or different in the molecule and can have the following definitions a)-d):
a) 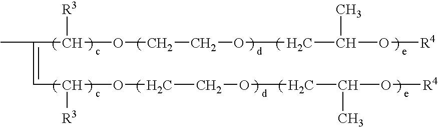
wherein
R³ is a hydrogen or alkyl radical,
R⁴ is a hydrogen, alkyl or carboxyl radical,
c is a number from 1 to 20,
d is a number from 0 to 50, e is a number from 0 to 50,
or
b) —(CH₂—)_{f}OR⁵,
wherein,
R⁵ is a hydrogen, alkyl, carboxyl radical or a dimethylolpropane radical optionally containing ether groups,
f is a number from 2 to 20,
or
c) —CH₂—)_{g}(OC₂H₄—)ₕ(OC₃H₆—)ᵢ(OC₄H₈)ⱼ(OCH₂CH(C₆H₅))ₖOR⁶
wherein
R⁶ is a hydrogen, alkyl or carboxyl radical,
g is a number from 2 to 6,
h is a number from 0 to 20,
i is a number from 1 to 50,
j is a number from 0 to 10,
k is a number from 0 to 10
or
d) correspond to the radical R¹, with the proviso that in the average molecule at least one radical R² has the definition (a), a being a number from 1 to 500 and b being a number from 0 to 10.

20. The paste according to claim 1, wherein the dispersant is a copolymer based on styrene oxide-based oxyalkylene glycol alkenyl ethers or polyalkylene oxide alkenyl ethers and unsaturated carboxylic acid, with
A) 1 to 80 mol % of at least one of the constituent groups of the formula 7a, 7b, 7c and/or 7d 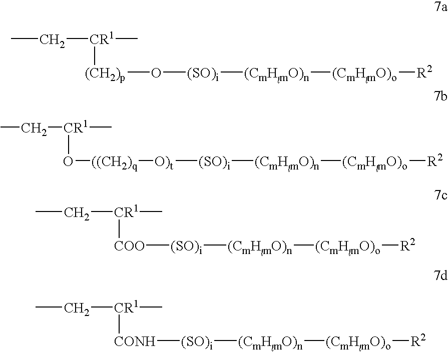
wherein
R¹═H, or an aliphatic hydrocarbon radical having 1 to 5 carbon atoms,
p=1-4, q=0-6, t=0-4, i=1-6, l=1-2, m=2-18,
the index on the H atom being formed by the product of l and m,
n=0-100, o=0-100, SO=styrene oxide,
it being possible for (SO)ᵢ and the alkylene oxide derivatives to be distributed randomly or blockwise in the polyether;
R²═H, an aliphatic, optionally branched hydrocarbon radical having 1 to 20 carbon atoms, a cycloaliphatic hydrocarbon having 5 to 8 carbon atoms, an aryl radical having 6 to 14 carbon atoms, which is optionally substituted or may be a phosphoric ester (preferably monoester) derivative, sulphate derivative or sulphonate derivative;
B) 1 to 90 mol % of constituent groups of the formula 8 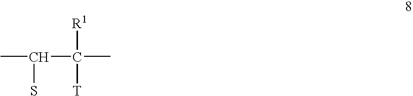
wherein
S═—H, —COOMₐ, or —COOR³,
M=hydrogen, monovalent or divalent metal cation, ammonium ion, or organic amine radical,
a=1 or if M is a divalent metal cation, is ½,
R³=an aliphatic, optionally branched hydrocarbon radical having 1 to 20 carbon atoms, a cycloaliphatic hydrocarbon having 5 to 8 carbon atoms, or an aryl radical having 6 to 14 carbon atoms,
T=-U¹-R⁴ or —U¹—(CₘHₗₘO)ₙ—(CₘHₘO)ₒ—R²,
U¹═—COO—, —CONH—, —CONR³—, —O—, or —CH₂O—,
R⁴═H, Mₐ, R³ or -Q¹-NQ²Q³,
wherein
Q¹ is a divalent alkylene radical having 2 to 24 carbon atoms,
Q² and Q³ are each, independently, aliphatic or alicyclic alkyl radicals having 1 to 12 carbon atoms, optionally oxidized to
-Q¹-N(+)O(−)Q²Q³
and
m, n, l, o, R¹ and R² are as defined above,
C) 0 to 10 mol % of constituent groups of the formula 9 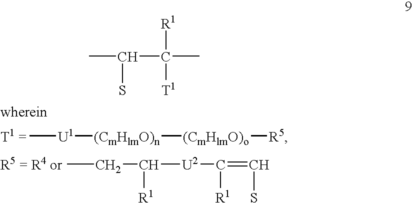
in which U²=—OOC—, —NHOC—, —O—, or —O—CH₂—, and m, n, l, o, S, R¹, R² and U¹ are as defined above.

21. The paste according to claim 1, wherein the solid phase is comprises a single nanoscale powder and the liquid phase is comprises a single dispersant.

22. A process for preparing the paste according to claim 1, wherein the nanoscale powder is incorporated all at once, continuously or in portions under dispersing conditions into the liquid phase.

23. A dispersion obtained from the paste according to claim 1 and one or more solvents.

24. The dispersion according to claim 19, wherein the nanoscale powder content is 0.5% to 50% by weight, based on the dispersion.

25. A process for preparing the dispersion according to claim 19, wherein the paste is combined by stirring or by shaking with a solvent or solvent mixture.

26. A paint comprising the paste according to claim 1 and a paint carrier medium.

27. An ink comprising the paste according to claim 1 and an ink carrier medium.

28. A coating formed from a composition comprising the paste according to claim 1.

29. An adhesive composition comprising the paste according to claim 1 and an adhesive.

30. A moulding formed from a composition comprising the paste according to claim 1.
